(19) United States
(12) Patent Application Publication
(10) Pub. No.: US 2006/0082156 A1
(43) Pub. Date: Apr. 20, 2006

(54) Clamp for PEX tubing/metal insert fitting

(76) Inventor: Gary L. Runyan, Plano, TX (US)

Correspondence Address: KONNEKER & SMITH P. C., 660 NORTH CENTRAL EXPRESSWAY, SUITE 230, PLANO, TX, 75074, US

(21) Appl. No.: 10/939,048

(22) Filed: Sep. 10, 2004

(51) Int. Cl. F16L 25/00

(52) U.S. Cl. 285/420

(57) ABSTRACT

A clamp for use in connecting flexible tubing to a rigid insert fitting. In one described embodiment, the clamp includes a clamp ring having a raised outer portion which is compressible to tighten the clamp about the tubing, and a liner sleeve positioned within the clamp ring, the liner sleeve having first and second sidewall portions, the first sidewall portion having a greater thickness than the second sidewall portion, and the first sidewall portion being positioned under the raised outer portion of the clamp ring.

### BACKGROUND

The present invention relates generally to equipment utilized and operations performed in conjunction with flexible piping or plumbing and, in an embodiment described herein, more particularly provides a clamp for a connection between PEX tubing and a metal or plastic insert fitting.

ASTM Standard F 1807 specifies a connection between cross-linked polyethylene (PEX) tubing and a metal insert fitting. ASTM Standard F 2159 specifies a connection between PEX tubing and a plastic insert fitting. The fitting is inserted into the tubing, and a copper ring is crimped or swaged about the tubing. The crimping operation compresses the ring, thereby forcing the tubing material into annular spaces between external ribs formed on the fitting.

ASTM Standard F 2098 specifies another type of connection between PEX tubing and a metal insert fitting. In this connection, a stainless steel clamp is used in place of the copper ring. The clamp is formed from a strip of stainless steel material having a mechanical interlock which maintains a circular configuration of the strip by attaching overlapping portions of the strip.

The strip itself is not circumferentially continuous. To compress the clamp, a raised outer portion of the strip is crimped together. The mechanical interlock prevents the overlapping portions of the strip from displacing relative to one another during the crimping operation.

It will be readily appreciated by those skilled in the art that improvements are needed in the art of clamping flexible tubing to metal or plastic insert fitting connections. For example, compressing the ring in the connections described in ASTM Standards F 1807 & F2159 requires a different sized crimping tool for each nominal tubing size.

Different tubing sizes may be accommodated by a single crimping tool in the connections described in ASTM Standard F 2098, but since the clamp is circumferentially discontinuous, the result is uneven compression about the tubing. Also, the mechanical interlock is formed by cutting away parts of the overlapping portions of the strip, which weakens the strip and results in problematic yielding when the raised portion of the strip is crimped, especially in colder environments where the flexible tubing is more stiff. Thus, another disadvantage of this type of connection is that the clamp produces varying amounts of compression in the tubing at different temperatures.

### SUMMARY

In carrying out the principles of the present invention, in accordance with one of multiple embodiments described below, a connection is provided which solves the above problems in the art. The connection and associated clamp permit convenient and effective use of cross-linked polyethylene tubing with rigid insert fittings, providing sealed and secure attachment of the tubing to the fitting.

In one aspect of the invention, a clamp for use in connecting flexible tubing to a rigid insert fitting is provided. The clamp includes a clamp ring having a raised outer portion which is compressible to tighten the clamp about the tubing. A liner sleeve is positioned within the clamp ring. The liner sleeve has different thickness sidewall portions, with the greater thickness sidewall portion being positioned under the raised outer portion of the clamp ring.

Another aspect of the invention includes a clamp which has a circumferentially continuous clamp ring and a circumferentially continuous liner sleeve positioned within the clamp ring.

In yet another aspect of the invention, a connection between a flexible tubing and a rigid insert fitting includes: the fitting received within an end portion of the tubing; a liner sleeve overlying the tubing end portion, the liner sleeve having first and second sidewall portions, the first sidewall portion having a greater thickness than the second sidewall portion; and a clamp ring overlying the liner sleeve, the clamp ring having a raised outer portion which is compressible to tighten the clamp ring about the liner sleeve and thereby seal and secure the tubing to the fitting.

In a further aspect of the invention, a connection between a flexible tubing and a rigid insert fitting includes: the fitting received within an end portion of the tubing; a circumferentially continuous liner sleeve overlying the tubing end portion; and a circumferentially continuous clamp ring overlying the liner sleeve.

These and other features, advantages, benefits and objects of the present invention will become apparent to one of ordinary skill in the art upon careful consideration of the detailed description of a representative embodiment of the invention hereinbelow and the accompanying drawings.

### BRIEF DESCRIPTION OF THE DRAWINGS

FIG. 1 is a cross-sectional view of a flexible tubing to rigid insert fitting connection embodying principles of the present invention;

FIG. 2 is side view of a clamp ring used in the connection of FIG. 1;

FIG. 3 is an end view of a liner sleeve used in the connection of FIG. 1;

FIG. 4 is cross-sectional view of the liner sleeve, taken along line 4-4 of FIG. 3; and

FIG. 5 is an enlarged scale cross-sectional view of the assembled clamp ring and liner sleeve.

### DETAILED DESCRIPTION

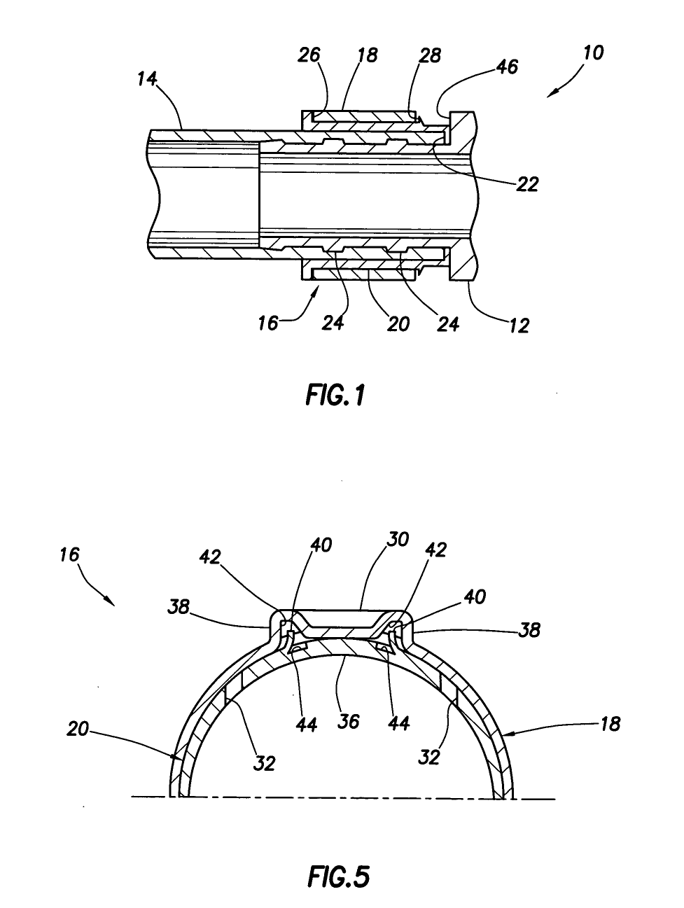

Representatively illustrated in FIG. 1 is a tubing/fitting connection 10 which embodies principles of the present invention. In the following description of the connection 10 and other apparatus and methods described herein, directional terms, such as “above”, “below”, “upper”, “lower”, etc., are used for convenience in referring to the accompanying drawings. Additionally, it is to be understood that the embodiment of the present invention described herein may be utilized in various orientations, such as inclined, inverted, horizontal, vertical, etc., and in various configurations, without departing from the principles of the present invention. The embodiment is described merely as one example of useful applications of the principles of the invention, which are not limited to any specific details of the embodiment.

As depicted in FIG. 1, the connection 10 includes a rigid insert fitting 12 received within an end portion of a flexible tubing 14. A uniquely configured clamp 16 is used to seal and secure the tubing 14 to the fitting 12.

The fitting 12 may be configured as specified in ASTM Standard F 1807 or F 2159, or another type of insert fitting may be used. The fitting 12 is made of a substantially rigid material, such as metal, a rigid plastic, etc. The tubing 14 is preferably made of a PEX material, but other types of materials may be used, if desired.

The clamp 16 is especially well suited for sealing and securing the tubing 14 to the fitting 12 where the tubing is made of a PEX material. The clamp 16 is designed to take into account the characteristics of PEX material by producing a uniform compression of the tubing 14 about the fitting 12, by consistently producing the same amount of compression at different temperatures of the PEX material, and by doing so in a convenient, easily reproducible manner. In addition, only a single tool is needed for different nominal sizes of the clamp 16, tubing 14 and fitting 12. Of course, these benefits may also be obtained if the tubing 14 is made of other materials.

The clamp 16 includes an outer circumferentially continuous clamp ring 18, which is preferably made of a stainless steel material. The clamp ring 18 outwardly overlies and encircles a liner sleeve 20, which is preferably made of a semi-rigid material, such as acetal, polypropylene, nylon, etc., which material is also preferably more rigid than a material of which the tubing 14 is made. The clamp ring 18 is used to supply a clamping force to compress the end portion of the tubing 14 about the fitting 12. The liner sleeve 20 is interposed between the clamp ring 18 and the tubing 14 to evenly distribute the clamping force about the end portion of the tubing.

Note that the liner sleeve 20 has an inwardly extending shoulder 22 formed thereon which engages an end of the tubing 14. This shoulder 22 retains the clamp 16 on the end portion of the tubing 14 prior to inserting the fitting 12 into the end of the tubing and accurately positions the clamp so that the clamp ring 18 is disposed opposite annular ribs 24 formed externally on the fitting. In this manner, the tubing 14 will be compressed between the clamp 16 and the annular ribs 24 when the clamp is tightened.

The clamp ring 18 is retained on the liner sleeve 20 by means of outwardly extending and oppositely facing shoulders 26, 28 formed on the liner sleeve. In this manner, the clamp ring 18 is appropriately positioned on the liner sleeve 20 in an axial direction, and the liner sleeve is appropriately interposed radially between the clamp ring and the end portion of the tubing 14 when the clamp 16 is tightened. This provides for convenient and accurate installation of the clamp 16 on the tubing 14, thereby providing for a more consistent and effective tubing/fitting connection 10.

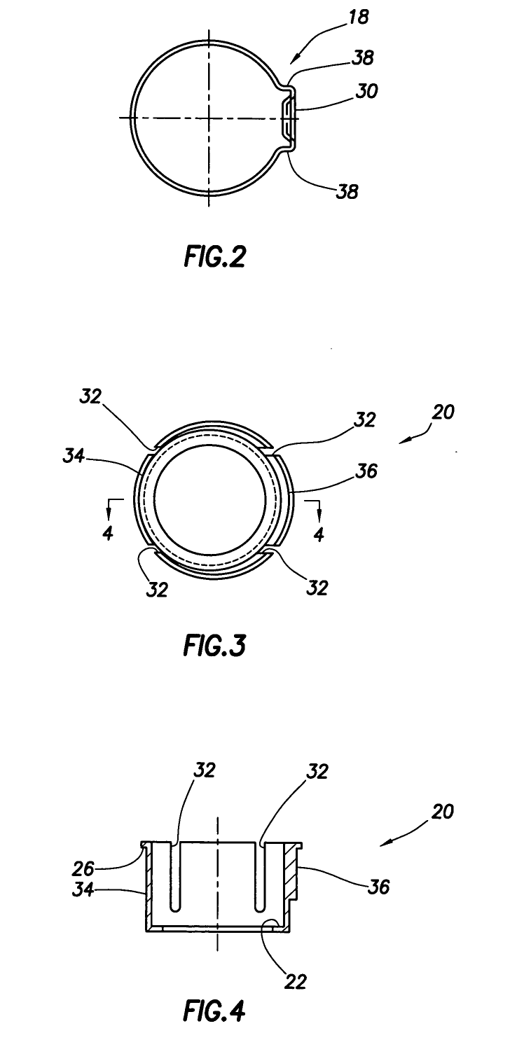

Referring additionally now to FIG. 2, the clamp ring 18 is depicted apart from the remainder of the clamp 16. In this end view of the clamp ring 18 it may be readily appreciated that the clamp ring is circumferentially continuous and is preferably constructed of a single piece of material.

A raised outer portion 30 is formed on the clamp ring 18 to provide for circumferential compression of the clamp ring. The outer portion 30 may be similar to the Detail ‘D’ described in ASTM Standard F 2098. A crimping tool such as the “ratcheting hand tool” described in the ASTM Standard F 2098 may be used to crimp the outer portion 30, thereby circumferentially shortening the clamp ring 18 and tightening the clamp ring about the liner sleeve 20.

Referring additionally now to FIG. 3, an end view of the liner sleeve 20 is depicted apart from the remainder of the clamp 16. In this view it may be seen that the liner sleeve 20 is also circumferentially continuous. However, the liner sleeve 20 could be circumferentially discontinuous without departing from the principles of the invention.

The liner sleeve 20 is provided with slots 32 which are uniquely configured so that they close off by overlapping the liner sleeve on opposite sides of the slots when the liner sleeve is compressed by the clamp ring 18. Note that the slots 32 extend between inner and outer surfaces of the liner sleeve 20 in a non-radial direction (i.e., the slots are not aligned in a radial direction relative to the liner sleeve). Thus, as the liner sleeve 20 is circumferentially compressed, opposite lateral sides of the slots 32 will overlap, ensuring that the clamping force exerted by the clamp ring 18 is evenly distributed from the liner sleeve to the tubing 14.

Referring additionally now to FIG. 4, a cross-sectional view of the liner sleeve 20 is depicted, taken along line 4-4 of FIG. 3. In this view it may be seen that the liner sleeve 20 has different thickness sidewall portions 34, 36. Specifically, the sidewall portion 36 has a greater thickness than does the sidewall portion 34.

When the clamp 16 is properly assembled, the thicker sidewall portion 36 is positioned under the raised portion 30 of the clamp ring 18. In this manner, any interior gap remaining in the clamp ring 18 between legs 38 of the raised portion 30 after it is crimped will be effectively bridged by the thicker sidewall portion 36, thereby ensuring that an evenly distributed compression loading is transmitted through the liner sleeve 20 to the tubing 14.

Note that FIG. 4 shows an alternate configuration of the liner sleeve 20, in which the shoulder 28 is not used. Only the shoulder 36 is used to retain the clamp ring 18 appropriately positioned on the liner sleeve 20. Of course, many different configurations of the liner sleeve 20 and clamp ring 18 may be used without departing from the principles of the invention.

Referring additionally now to FIG. 5, a cross-sectional view of the clamp 16 is depicted. In this view, a manner of retaining the clamp ring 18 so that the raised portion 30 is appropriately positioned relative to the thicker sidewall portion 36 of the liner sleeve 20 may be seen.

Circumferentially spaced apart projections 40 are formed on the liner sleeve 20 extending outwardly from the sidewall portion 36. These projections 40 engage recesses 42 formed within the raised portion 30 of the clamp ring 18. For example, the recesses 42 may comprise inner surfaces of the legs 38. In an alternate configuration, one or more projections could be formed on the clamp ring 18 to engage corresponding recesses formed on the liner sleeve 20, if desired, or another means could be used to rotationally orient the clamp ring relative to the liner sleeve.

When the clamp ring 18 is tightened, the legs 38 will displace toward each other. Preferably, the projections 40 will fold down into cavities 44 formed on the liner sleeve 20, so that a relatively smooth outer surface of the liner sleeve is obtained when the clamping force exerted by the clamp ring 18 is transmitted through the liner sleeve to the tubing 14.

In use, the assembled clamp 16 with the clamp ring 18 appropriately positioned on the liner sleeve 20 is installed on the end portion of the tubing 14.

The shoulder 22 engages the end of the tubing 14 to appropriately position the clamp 16 relative to the end of the tubing. The fitting 12 is then inserted into the end of the tubing 14, until the clamp 16 engages a shoulder 46 on the fitting (see FIG. 1). The clamp 16 is, thus, sandwiched longitudinally between the end of the tubing 14 and the shoulder 46 on the fitting 12, which positions the clamp ring 18 over the ribs 24 on the fitting.

The clamp ring 18 is then tightened by compressing the raised portion 30.

This compresses the liner sleeve 20 radially inward, thereby compressing the tubing 14 against the ribs 24 on the fitting 24. As a result, the tubing 14 is sealed and secured to the fitting 12.

Of course, a person skilled in the art would, upon a careful consideration of the above description of a representative embodiment of the invention, readily appreciate that many modifications, additions, substitutions, deletions, and other changes may be made to this embodiment, and such changes are contemplated by the principles of the present invention. Accordingly, the foregoing detailed description is to be clearly understood as being given by way of illustration and example only, the spirit and scope of the present invention being limited solely by the appended claims and their equivalents.

What is claimed is:

1. A clamp for use in connecting flexible tubing to a rigid insert fitting, the clamp comprising:
a clamp ring having a raised outer portion which is compressible to tighten the clamp about the tubing; and
a liner sleeve positioned within the clamp ring, the liner sleeve having first and second sidewall portions, the first sidewall portion having a greater thickness than the second sidewall portion, and the first sidewall portion being positioned under the raised outer portion of the clamp ring.

2. The clamp of claim 1, wherein engagement between a projection and a recess maintains the first sidewall portion positioned under the raised outer portion of the clamp ring.

3. The clamp of claim 1, wherein the liner sleeve is slotted lengthwise, thereby permitting circumferential compression of the liner sleeve.

4. The clamp of claim 1, wherein one or more slots formed lengthwise through the liner sleeve extend between an interior and an exterior of the liner sleeve in a non-radial direction.

5. The clamp of claim 1, wherein one or more slots formed lengthwise through the liner sleeve are configured to permit overlapping of the liner sleeve on opposites sides of the slots when the liner sleeve is circumferentially compressed.

6. The clamp of claim 1, wherein the clamp ring is circumferentially continuous.

7. The clamp of claim 1, wherein the liner sleeve is circumferentially continuous.

8. The clamp of claim 1, wherein the liner sleeve is circumferentially discontinuous.

9. The clamp of claim 1, wherein the liner sleeve further includes an inwardly extending shoulder for engaging an end of the tubing.

10. The clamp of claim 1, wherein the liner sleeve further includes a first outwardly extending shoulder which engages the clamp ring to retain the clamp ring on the liner sleeve.

11. The clamp of claim 10, wherein the liner sleeve further includes a second outwardly extending shoulder which engages the clamp ring, the first and second shoulders preventing the clamp ring from displacing off of the liner sleeve.

12. The clamp of claim 1, wherein the clamp ring is made of stainless steel material.

13. The clamp of claim 1, wherein the liner sleeve is made of acetal material.

14. The clamp of claim 1, wherein the liner sleeve is made of polypropylene material.

15. The clamp of claim 1, wherein the liner sleeve is made of nylon material.

16. The clamp of claim 1, wherein the liner sleeve is made of a first material having greater rigidity than a second material of which the flexible tubing is made.

17. A clamp for use in connecting flexible tubing to a rigid insert fitting, the clamp comprising:
a circumferentially continuous clamp ring; and
a circumferentially continuous liner sleeve positioned within the clamp ring.

18. The clamp of claim 17, wherein the clamp ring has a raised outer portion formed thereon which is compressible to tighten the clamp about the tubing.

19. The clamp of claim 18, wherein the liner sleeve includes first and second sidewall portions, the first sidewall portion having a greater thickness than the second sidewall portion, and the first sidewall portion being positioned under the raised outer portion of the clamp ring

20. The clamp of claim 19, wherein engagement between a projection and a recess maintains the first sidewall portion positioned under the raised outer portion of the clamp ring.

21. The clamp of claim 17, wherein the liner sleeve is slotted lengthwise, thereby permitting circumferential compression of the liner sleeve.

22. The clamp of claim 17, wherein one or more slots formed lengthwise through the liner sleeve extend between an interior and an exterior of the liner sleeve in a non-radial direction.

23. The clamp of claim 17, wherein one or more slots formed lengthwise through the liner sleeve are configured to permit overlapping of the liner sleeve on opposites sides of the slots when the liner sleeve is circumferentially compressed.

24. The clamp of claim 17, wherein the liner sleeve further includes an inwardly extending shoulder for engaging an end of the tubing.

25. The clamp of claim 17, wherein the liner sleeve further includes a first outwardly extending shoulder which engages the clamp ring to retain the clamp ring on the liner sleeve.

26. The clamp of claim 25, wherein the liner sleeve further includes a second outwardly extending shoulder which engages the clamp ring, the first and second shoulders preventing the clamp ring from displacing off of the liner sleeve.

27. The clamp of claim 17, wherein the clamp ring is made of stainless steel material.

28. The clamp of claim 17, wherein the liner sleeve is made of acetal material.

29. The clamp of claim 17, wherein the liner sleeve is made of polypropylene material.

30. The clamp of claim 17, wherein the liner sleeve is made of nylon material.

31. The clamp of claim 17, wherein the liner sleeve is made of a first material having greater rigidity than a second material of which the flexible tubing is made.

32. A connection between a flexible tubing and a rigid insert fitting, the connection comprising:
the fitting received within an end portion of the tubing;
a liner sleeve overlying the tubing end portion, the liner sleeve having first and second sidewall portions, the first sidewall portion having a greater thickness than the second sidewall portion; and
a clamp ring overlying the liner sleeve, the clamp ring having a raised outer portion which is compressible to tighten the clamp ring about the liner sleeve and thereby seal and secure the tubing to the fitting.

33. The connection of claim 32, wherein the tubing is made of a cross-linked polyethylene material.

34. The connection of claim 32, wherein the first sidewall portion is positioned under the raised outer portion of the clamp ring.

35. The connection of claim 32, wherein engagement between a projection and a recess maintains the first sidewall portion positioned under the raised outer portion of the clamp ring.

36. The connection of claim 32, wherein the liner sleeve is slotted lengthwise, thereby permitting circumferential compression of the liner sleeve.

37. The connection of claim 32, wherein one or more slots formed lengthwise through the liner sleeve extend between an interior and an exterior of the liner sleeve in a non-radial direction.

38. The connection of claim 32, wherein one or more slots formed lengthwise through the liner sleeve are configured to permit overlapping of the liner sleeve on opposites sides of the slots when the liner sleeve is circumferentially compressed.

39. The connection of claim 32, wherein the clamp ring is circumferentially continuous.

40. The connection of claim 32, wherein the liner sleeve is circumferentially continuous.

41. The connection of claim 32 wherein the liner sleeve is circumferentially discontinuous.

42. The connection of claim 32, wherein the liner sleeve further includes an inwardly extending shoulder for engaging an end of the tubing.

43. The connection of claim 32, wherein the liner sleeve further includes a first outwardly extending shoulder which engages the clamp ring to retain the clamp ring on the liner sleeve.

44. The connection of claim 43, wherein the liner sleeve further includes a second outwardly extending shoulder which engages the clamp ring, the first and second shoulders preventing the clamp ring from displacing off of the liner sleeve.

45. The connection of claim 32, wherein the clamp ring is made of stainless steel material.

46. The connection of claim 32, wherein the liner sleeve is made of acetal material.

47. The connection of claim 32, wherein the liner sleeve is made of polypropylene material.

48. The connection of claim 32, wherein the liner sleeve is made of nylon material.

49. The connection of claim 32, wherein the liner sleeve is made of a first material having greater rigidity than a second material of which the flexible tubing is made.

50. A connection between a flexible tubing and a rigid insert fitting, the connection comprising:
the fitting received within an end portion of the tubing;
a circumferentially continuous liner sleeve overlying the tubing end portion; and
a circumferentially continuous clamp ring overlying the liner sleeve.

51. The connection of claim 50, wherein the tubing is made of a cross-linked polyethylene material.

52. The connection of claim 50, wherein the clamp ring has a raised outer portion formed thereon which is compressible to tighten the clamp about the tubing.

53. The connection of claim 52, wherein the liner sleeve includes first and second sidewall portions, the first sidewall portion having a greater thickness than the second sidewall portion, and the first sidewall portion being positioned under the raised outer portion of the clamp ring.

54. The connection of claim 53, wherein engagement between a projection and a recess maintains the first sidewall portion positioned under the raised outer portion of the clamp ring.

55. The connection of claim 50, wherein the liner sleeve is slotted lengthwise, thereby permitting circumferential compression of the liner sleeve.

56. The connection of claim 50, wherein one or more slots formed lengthwise through the liner sleeve extend between an interior and an exterior of the liner sleeve in a non-radial direction.

57. The connection of claim 50, wherein one or more slots formed lengthwise through the liner sleeve are configured to permit overlapping of the liner sleeve on opposites sides of the slots when the liner sleeve is circumferentially compressed.

58. The connection of claim 50, wherein the liner sleeve further includes an inwardly extending shoulder for engaging an end of the tubing.

59. The connection of claim 50, wherein the liner sleeve further includes a first outwardly extending shoulder which engages the clamp ring to retain the clamp ring on the liner sleeve.

60. The connection of claim 59, wherein the liner sleeve further includes a second outwardly extending shoulder which engages the clamp ring, the first and second shoulders preventing the clamp ring from displacing off of the liner sleeve.

61. The connection of claim 50, wherein the clamp ring is made of stainless steel material.

62. The connection of claim 50, wherein the liner sleeve is made of acetal material.

63. The connection of claim 50, wherein the liner sleeve is made of polypropylene material.

64. The connection of claim 50, wherein the liner sleeve is made of nylon material.

65. The connection of claim 50, wherein the liner sleeve is made of a first material having greater rigidity than a second material of which the flexible tubing is made.
